(19) United States
(12) Patent Application Publication
(10) Pub. No.: US 2014/0008496 A1
(43) Pub. Date: Jan. 9, 2014

(54) USING HANDHELD DEVICE TO CONTROL FLYING OBJECT

(71) Applicants: Zhou Ye, Foster City, CA (US); Ying-Ko Lu, Taoyuan County (TW)

(72) Inventors: Zhou Ye, Foster City, CA (US); Ying-Ko Lu, Taoyuan County (TW)

(21) Appl. No.: 13/541,766

(22) Filed: Jul. 5, 2012

(51) Int. Cl. B64C 13/20

(52) U.S. Cl. 244/190

(57) ABSTRACT

Method and system for remote control of a drone helicopter and RC plane using a handheld device is disclosed. Piloting commands and actions are performed using the handheld device, which includes a motion sensor module, with gyro-sensor and g-sensor for controlling roll, yaw and pitch of flying object under relative or absolute coordinate system. The gyro-sensor controls both heading and rotation of flying object in place around its yaw by rotating handheld device around its yaw axis; g-sensor controls pitch and roll by rotating handheld device around its pitch axis and roll axes. Upon determining free falling of flying object, throttle is thereby adjusted so as to land it safely. Flying object further has a camera, and video images are transferred wireless to be displayed on touch screen, and image zoom-in and zoom-out are provided via multi-touch of touch screen. RF and IR capability is included for wireless communication.

The present invention relates to remotely controlling of a flying object, and in particular, to a method and system for remote controlling a drone, such as helicopters and the like, and an RC plane using a handheld device.

### BACKGROUND OF THE INVENTION

Some of the most popular RC toys seen today are flying objects such as RC helicopters and airplanes. In recent years, a toy quadricopter was seen in the market. This conventional remote control drone is, for example, the AR.Drone offered by Parrot S A; it is a toy quadricopter equipped with three-axis accelerometers and gyros, an altimeter, a vertically-directed camera and an automatic stabilization system for stabilizing the drone during hovering. The AR.Drone can be remote-controlled using an iPhone®, iPod touch® or iPad™. It is also provided with a front camera for capturing real-time video images as viewed at the front of the AR.Drone itself. For the AR.drone. inertial measurements are used for automatic pitch, roll and yaw rotational stabilization and assisted tilting control. In addition, an ultrasound telemeter provides for altitude measures for automatic altitude stabilization and assisted vertical speed control for the AR.Drone.

The automatic stabilization system of the AR.Drone enables it to reach a stationary point in the air automatically, and maintains the ability to hover automatically once the stationary point has been reached, and to provide the necessary continuous corrections needed for maintaining flying at the stationary point via trimming due to external disturbances such as wind or drifting of the sensors.

The handheld device herein referred to in instant disclosure as a “smartphone device” can be, for example, an Android™ phone, iPhone®, or the like, or including other similar mobile touch-screen electronic devices such as, iPod touch® or iPad™ or Android™ tablet devices, or the like, which are not telephones in the conventional sense, but nevertheless, can take on telephone functionalities through broadband wireless Internet connectivity.

The wireless connection link herein referred can be for example a WiFi (IEEE 802.11), radio frequency (RF), infrared (IR), Bluetooth™ type, or the like, wireless local area network.

A conventional flying object is typically piloted by using a handheld device that has a touch screen (acting as the remote-control device of the flying object), a wireless transceiver for providing wireless communication between the handheld device and the flying object, and two-axis inclination sensors for sensing the attitude of the flying object relative to a reference vertical direction associated with a terrestrial frame of reference. The screen of the handheld device would reproduces the video images captured by the on-board front camera of the flying object as transmitted over wireless communication link, together with various piloting and command button symbols that are superposed on the displayed image on the touch screen of the handheld device so as to enable various commands to be activated by the user via finger gesture through contact with the touch screen.

Two conventional piloting modes are popularly known for flight control of a remote-controlled flying object, one can be called a “floating mode” in which the automatic stabilization system of the drone is activated to provide automatic hovering of the drone at a stationary point. The second piloting mode, can be referred herein as a “controlled mode”, which is an operating mode in which the drone is piloted directly by the user via performing one or more piloting actions on the flying object comprising roll, pitch, and yaw of the flying object under a coordinate system.

Conventionally, flight control of the flying object by an user can be achieved by means of performing the following actions: (a) for forward pitch advancement of the flying object, the user tilts the handheld device about the corresponding pitching axis, (b) for moving the flying object to the right or the left, the user tilts the handheld device relative to the roll axis; (c) for performing throttle changes for making the flying object fly faster or slower, the user depresses the “up/down” command buttons displayed on the touch screen; and (d) for pivoting or rotating about a yaw axis of the flying object, the user depresses “left/right” command buttons displayed on the touch screen.

The switching from the floating mode to the controlled mode is achieved by pressing the user's finger on a specific command button displayed on the touch screen, and the pressing of a “controlled mode activate” command button causes the controlled mode to be activated immediately, and would remain activated so long as a “floating mode activate” or “controlled mode deactivate” command button has not been depressed.

One drawback of the conventional method for remote control of a flying object is that the user must sometimes stop looking at the drone, during periods when the drone is flying under the controlled mode, to instead look at the handheld device for performing some other remote control functions (which is awkward for the user since the drone is piloted at sight) as well as having to make various fingers gestures on the touch screen of the handheld device for making additional piloting maneuvers. Since it is obviously much easier to control the movements of the drone by only looking at the drone or the flying object itself, rather than having to look at the video images being of narrow field of view and blurry quality returned by the on-board camera, the ability to provide full range of accurate piloting adjustments for pitch, roll, and yaw of the flying object while maintaining continuous visual contact with the flying object when making the corresponding piloting actions or maneuvers using the handheld device by the operator would be a much better option.

Another drawback of the conventional remote-controlled plane is that for turning left or right of the RC plane, the RC plane typically relies on the making of a roll to the right or left, or banking left or right, to make such turns, rather than using a rudder to make yaw rotations. Meanwhile, another drawback of the conventional remote control helicopter drone is that it cannot produce roll actions through the same roll action control motions as made on the handheld device acting as remote control device. Furthermore, the AR.Drone and the RC plane both cannot reproduce yaw actions through the same type of yaw action control motions made on the handheld device itself.

Another drawback of conventional remote-control radios for controlling the piloting actions of the RC plane is that typically it is much more difficult for the user to learn how to properly use the remote control radio because it has too many adjustment items, such as including, at least two control sticks, trims; and, if the radio/transmitter set has 5 or more channels, it also has switches and rotating dials.

Meanwhile, another drawback of conventional drone quadricopters such as the AR.Drone is that it requires to have independent and precise control and adjustment of each of the four rotors attached to the four ends of a crossing of its body, where each pair of opposite rotors is turning the same rotational direction, so that one pair of rotors is turning clockwise and the other pair of rotors is turning counter-clockwise, in order to provide flight control in yaw, roll, and pitch of the drone.

Another drawback of conventional drone quadricopters is that piloting control maneuvers made by tilting or rotating the handheld device for pitch, roll and yaw angular changes or adjustments on the handheld device itself do not directly translate to actual corresponding flying object orientation changes with regards to pitch, roll, and yaw.

Another drawback of conventional drones is that it is typically not equipped with any nine-axis motion sensor having a magnetic sensor for producing output parameters such as magnetic flux, and flying object orientation value in an absolute terrestrial coordinate.

Another drawback of conventional remote control planes and helicopter type flying objects is that upon situations in which the flying object experiences any flight emergency, thereby causing the flying object to free fall from high altitude into the ground, the user through the remote control radio or the handheld device acting as remote control cannot properly save the flying object in time.

Another drawback of conventional remote control helicopter drones is that there is no automatic power saving capability, so that the drone cannot reduce or adjust the amount of power consumption and throttle when controlling the rotation speed of its propellers to maintain a particular flying height.

Therefore, there is room for improvement in the art.

### SUMMARY OF THE INVENTION

The present invention is directed to a method and system for remote control of an aircraft, such as a helicopter aircraft or a jet aircraft, using a handheld device.

The present invention is further directed to a method and system for remote control of an RC plane using a handheld device through a motion and touch sensing way.

According to an aspect of the invention, a method to perform one or more piloting actions for controlling the flying object based on one or more piloting commands via an operator's motion gestures is used, and the handheld device further comprises a motion sensor module that includes at least a gyro-sensor and an acceleration sensor (hereinafter referred to as “g-sensor”) to measure three-dimensional movements of the handheld device representative of the piloting commands that are associated with motion gestures; and the one or more piloting actions are generated based on the motion-related piloting commands so as to control roll, yaw, and pitch angles and translation movements of the flying object.

According to another aspect of the invention, a method is used to perform one or more piloting actions for controlling the flying object based on one or more piloting commands via an operator's gestures, and the handheld device has a motion sensor module which includes a g-sensor, a gyro-sensor, and a magnetic-sensor so as to generate one or more motion data in the form of acceleration, angular speed and magnetic flux.

According to another aspect of the invention, a method to perform one or more piloting actions for controlling the flying object based on part of the piloting commands associated with an operator's touch gestures is used, and the one or more piloting commands are activated by making finger gestures on a touch screen of the handheld device, and a wireless communication link between the handheld device and the flying object is established while the flight inspection is enabled, and the piloting actions can be indicative of pitch, roll, and roll performed on the flying object.

The present invention further provides a handheld device with a motion sensor module having a gyro-sensor and a g-sensor for controlling a flying object, where the gyro-sensor correspondingly controls the heading of the flying object by rotating the handheld device around its yaw axis; and where the g-sensor correspondingly controls the pitch and roll rotations of the flying object by tilting the handheld device around its pitch axis and roll axes, respectively.

The present invention further provides that the flying object can be a remote-controlled helicopter aircraft or a remote-controlled jet aircraft, or the like, capable of flying to a designated elevation and hovering in place while maintaining substantial positional and rotational stability

The present invention further provides that the flying object includes one or more motors or engines for driving one or more propellers or jets, respectively.

The present invention further provides that, during a flight session of the flying object, upon determining that the flying object is free falling from the air by calculating three axial measured values from a g-sensor disposed on the flying object, and that Gsum is equal to zero from the expression: Gsum=sqrt(Gx̂2+Gŷ2+Gẑ2)=0, such that the throttle of the one or more motors or engines of the flying object is thereby increasingly driven to rotate the corresponding one or more propellers accordingly for the purpose of landing the flying object safely without substantial damage to the flying object or even flying crash.

The present invention further provides that a flying object is equipped with a camera for capturing video images that are wirelessly transmitted to and displayed on the touch screen of the handheld device, and the video images can be performed as zoom-in/zoom-out using realtime zoom-focus via the multi-touch functionality of the touch screen through a slide bar operated by at least one finger, or via one or more multi-touch de-pinch/pinch touch gestures.

The present invention further provides a method to execute a power saving action that is performed by detecting a value of the flying object's height measured from the ground via one or more readings obtained from an altimeter or a pressure sensor disposed on the flying object to automatically adjust the amount of power consumption for the purpose of both maintaining the flying object at a specified height from the ground in a power saving way, and/or controlling the rotating speed of the one or more propellers or jets to prevent the flying object from crash.

The present invention further provides a remote-controlled flying object system, and the system comprises a flying object, a handheld device, and a wireless communication unit to communicate the flying object with the handheld device. The flying object is attached with a g-sensor to prevent a flying crash. The wireless communication unit provides a wireless communication link between the flying object and the handheld device via a plurality of infrared or radio-frequency signals. The handheld device has a touch screen, a motion sensor module with a gyro-sensor and a g-sensor for controlling roll, yaw and pitch angles and movement translations of the flying object, a flight control and piloting interface for displaying one or more specified piloting icons or symbols on the touch screen and generalizing a plurality of piloting commands in response to the activation from each corresponding touch icons or symbols on the touch screen, and a flight control software program configured to communicate the flight control and piloting interface with the motion sensor module for interpreting the plurality of piloting commands respectively from the flight control and piloting interface and the motion sensor module, and subsequently for generating a plurality of piloting actions based on the plurality of piloting commands. Each of the piloting actions indicates one of roll, yaw, and pitch rotations and/or movement translations for controlling the flying object through the wireless communication link.

The present invention further provides a remote-controlled flying object system using the handheld device that has the motion sensor module in which the gyro-sensor controls the heading of the flying object by rotating the handheld device around its yaw axis, and controls the pitch and roll of the flying object by tilting the handheld device around its pitch axis and roll axes, respectively, so as to maintain an orientation of the flying object during the flight session.

### BRIEF DESCRIPTION OF THE DRAWINGS

The present invention is illustrated by way of example and not limitation in the figures of the accompanying drawings in which like references indicate similar elements. Besides, many aspects of the disclosure can be better understood with reference to the following drawings. Moreover, in the drawings like reference numerals designate corresponding elements throughout. Wherever possible, the same reference numerals are used throughout the drawings to refer to the same or like elements of an embodiment.

FIG. 1 is a flowchart illustrating an exemplary method of implementing remote control of a flying object using a handheld device according to an embodiment.

FIG. 2 is a block diagram showing a wireless communication electronic module connected to the handheld device of the embodiment for enabling the wireless communication link between the flying object and the handheld device.

FIGS. 3A-3B show two block diagrams illustrating one remote-controlled flying object system with a motion sensor module having a gyro-sensor and a g-sensor, and another remote-controlled flying object system with a motion sensor module having a gyro-sensor, a g-sensor and a magnetic sensor, respectively.

FIG. 3C shows a block diagram illustrating the handheld device of the remote-controlled flying object system according to the embodiment.

FIG. 4 shows an orientation of the handheld device with respect to the corresponding orientations of the flying object, including pitch, yaw, and roll according to the embodiment of present invention.

### DETAILED DESCRIPTION OF THE INVENTION

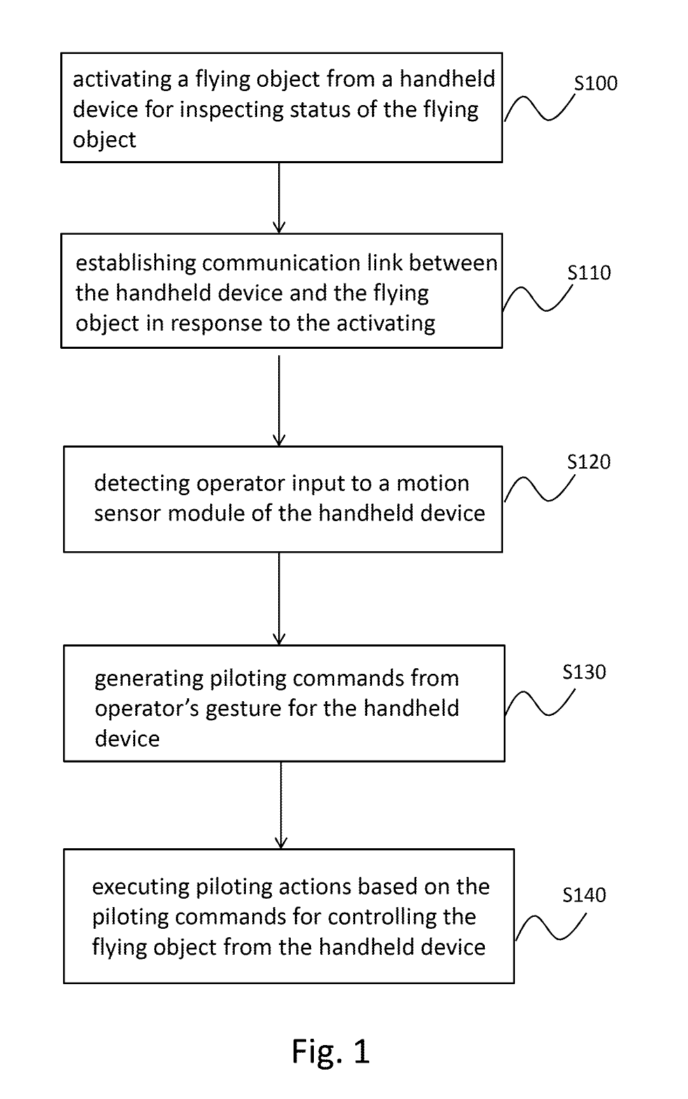

Referring to FIG. 1, a method for implementing remote-control of a flying object using a handheld device (hereinafter referred to as “smartphone” device) according to a first embodiment of the instant disclosure is shown. The handheld device can also be a mobile phone, a personal digital assistance (PDA), a tablet PC, a laptop PC, a pad-phone, an ultra-mobile PC, remote controller or the like. The remote-control implementation method of the first embodiment as illustrated in FIG. 1 includes the following steps.

In step S100, an operator uses one or two hands to perform touch/motion gestures at a handheld device to activate a flying object controlled by the handheld device for inspecting the initial status of the flying object when ready for starting a flight session. In case of touch gesture, the operator makes one or more finger gestures through his/her one or two hands on a touch screen of the handheld device at a specified icon such as a “flight initiation” key, or moves over the touch screen at a specified location indicating “flight initiation” symbol/button which is displayed on the touch screen for the operator's view. In case of motion gesture, the operator may shake the handheld device in a particular motion gesture to indicate that she/he wants to inspect the initial status of the flying object, and the status inspection can include part or all of the following functions. For example, a “START” function is usually provided in the first step for activating a wireless communication link between the flying object and the handheld device when the operator has decided to initiate the flight session of the flying object; “TEST” function is subsequently provided for the operator with inspecting the whole flying object's status to determine whether any essential parts (e.g. engines/propellers, image sensors, motion sensors, lighting/sounds, radar detector, and so forth) can be normally operated under ordinary conditions; an “OFF” function is provided for turning off the throttle to the engines or propellers of the flying object and/or ending the wireless communication between the flying object and the handheld device when the operator desires to terminate the flight session.

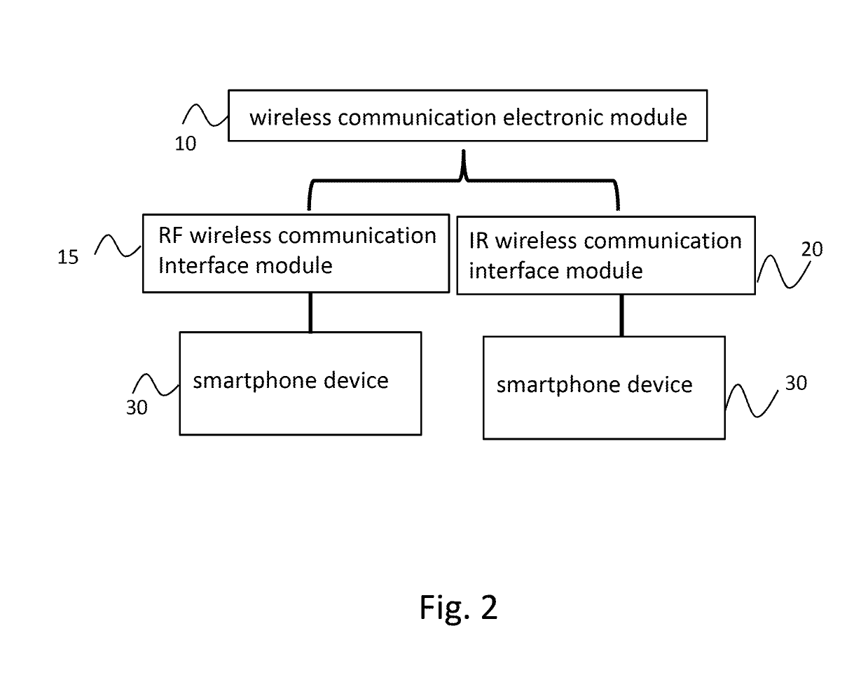

In step S110, a wireless communication link between the flying object and the handheld device can be established using WiFi (IEEE 802.11 a/b/g/n), radio frequency (RF), infrared (IR), Bluetooth™ type or the like, in response to the step S100 (e.g. after completion of the inspection step S100). Alternately, the wireless communication link can be established prior to the initial inspection as well. In FIG. 2, a wireless communication electronic module 10 such as a RF wireless communication interface module 15 or an IR wireless communication interface module 20 is required for establishing a two-way wireless communication link by coupling either the RF wireless communication interface module 15 or the IR wireless communication interface module 20 to a handheld device 30 from a flying object. The communication electronic module comprising a wireless communication unit is provided at the handheld device and the flying object, respectively, for establishing a wireless communication link between the handheld device and the flying object.

In step S120, detection of the operator's input to the motion sensor module of the handheld device is performed before the motion sensor module can be enabled to measure three-dimensional movements of the handheld device. Particularly when the operator activates such a “gyro-sensor enable” key/button that the motion sensor module is being informed to measure his/her motion gestures like yaw/roll/pitch rotations and/or translation movements on the handheld device for controlling the flying object's flight orientation.

In step S130, one or more piloting commands are performed on the handheld device when the operator desires to pilot the flying object during the flight session. For touch-oriented piloting commands, the operator makes one or more finger gestures on a touch screen of the handheld device at a specified icon, or moves over the touch screen at a specified location indicating symbol/button, and thus a flight control and piloting interface (e.g. user interface for touch screen) is provided to receive the operator's touch gestures, and then piloting commands are generated and outputted to a flight control software program. For motion-oriented piloting commands, the operator may perform his/her motions on the handheld device with his/her unique motion gesture to indicate how she/he desires to pilot the flying object, and thus the motion sensor module is provided to receive the operator's motion gestures detected from the g-sensor and gyro-sensor and/or magnetic sensor in the motion sensor module, and then piloting commands are generated and outputted to the flight control software program. During the flight session, for example, a piloting command is provided to display a “throttle” bar for the operator so as to allow his/her touch and/or motion gestures to control the throttle amount and air speed of the flying object for speeding up or slowing down thereof; a “zoom in/out” piloting command is provided for activating a camera's zoom-in/out function by pinch/de-pinch touch gestures on the touch screen of the handheld device when the flying object is attached with the camera to implement image-capturing (e.g. still images or moving/video images) and zoom-in/out functions; a “flight orientation” command is provided for the motion gesture so as to allow the operator to pilot the flying object along at least one of roll, yaw and pitch axial rotations combined with at least one of forward, backward, leftward and rightward translation movements directed by the UI-touch icon/symbol/button. Therefore, each of the piloting command from the operator input to the handheld device can activate at least one or a series of related piloting actions (detailed in the following step) which can be generated by a flight control software program resided in the handheld device so as to allow the operator to control the flight orientation in a realtime manner.

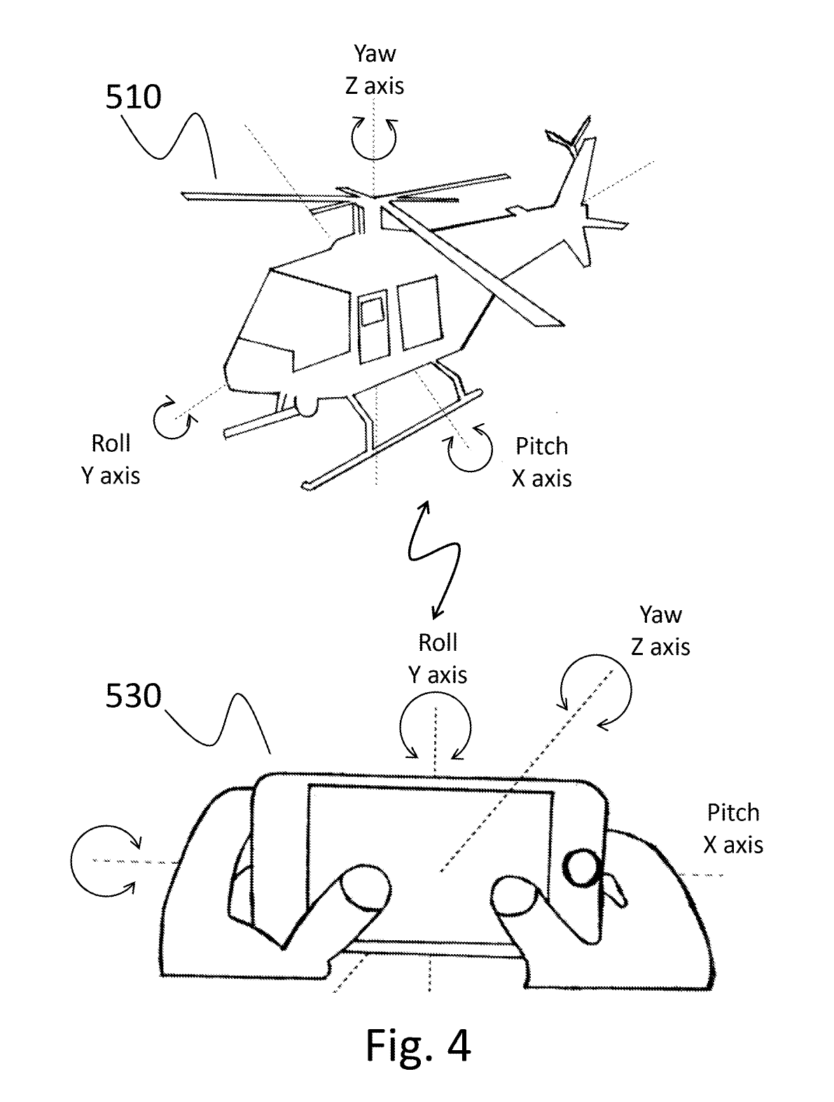

In step S140, the piloting actions are generated by the flight control software program based on the piloting commands generated by the flight control and piloting interface so as to implement the actual orientation of the flying objects such as the roll, yaw, and pitch rotations and/or translation movement. It is noted that the one or more piloting actions are processed by the flight control software program resided in the handheld device so as to maintain an orientation of the flying object, and the orientation is indicative of at least one of a roll, yaw and pitch angles, and translation thereof during flight. The gyro-sensor of the handheld device is provided to transmit its one or more motion signals in response to the operator input to the gyro-sensor of the motion sensor module so as to control a flight heading of the flying object around its yaw axis (shown in FIG. 4) while the handheld device is rotated by the operator around its yaw axis (shown in FIG. 4). The g-sensor of the handheld device is provided to transmit its one or more motion signals through tilting the handheld device around at least one of its pitch and roll axes, so as to control a flight translation of the flying object or the pitch and roll angles.

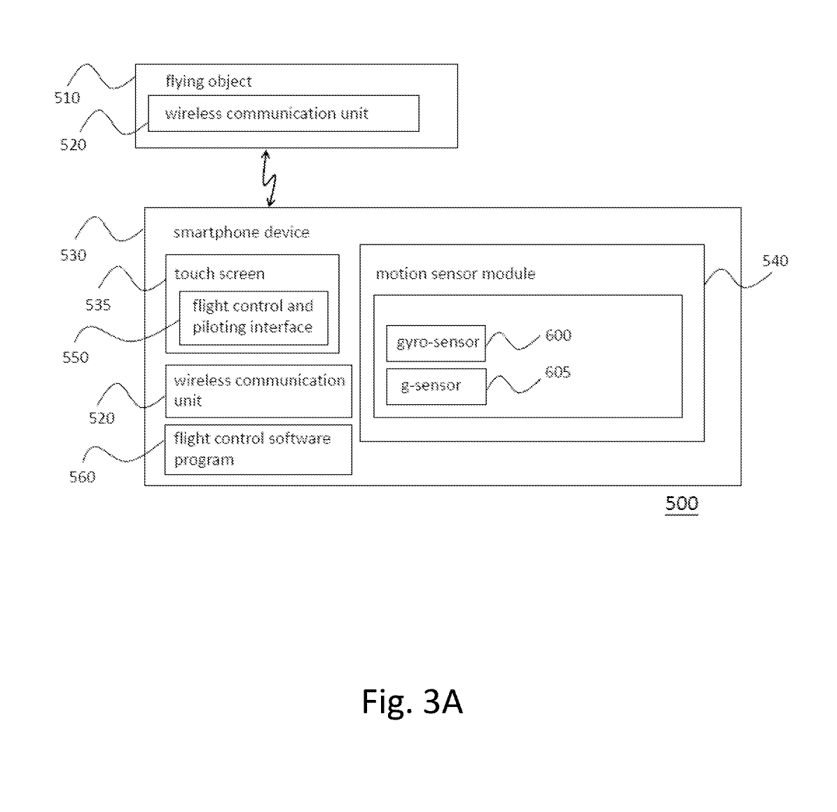

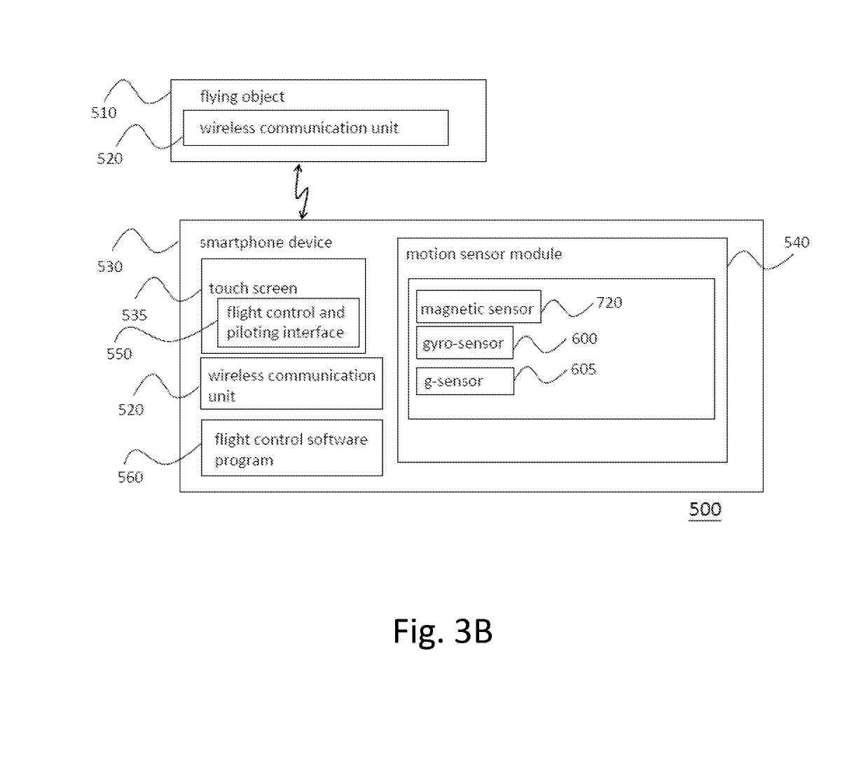

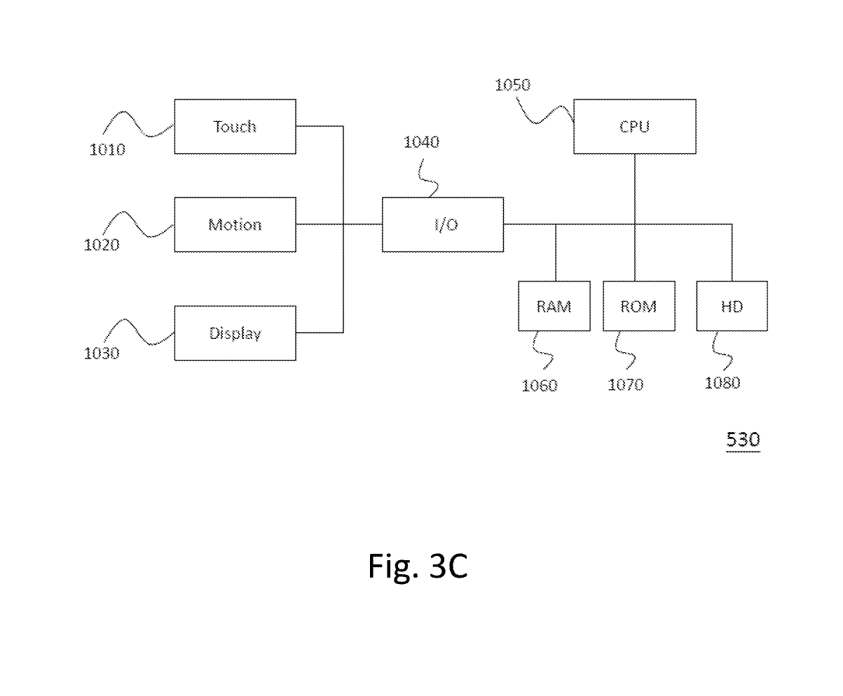

Referring to FIG. 3A, it is a block diagram of a second embodiment of a remote-controlled flying object system 500 with a motion sensor module 540 that includes a gyro-sensor 600 and a g-sensor 605. The gyro-sensor 600 of the motion sensor module 540 comprises at least one axis (shown in FIG. 4), and the g-sensor 605 of the motion sensor module 540 comprises at least two axes. The motion sensor module 540 is provided to measure motion signals when the handheld device is operated at three-dimensional movements. The motion signals can be output parameters representative of one or more motion data in acceleration and angular speed, so as to calculate orientation values, gravity changes and linear accelerations of the flying object.

Referring to FIG. 3B, it is a block diagram of a third embodiment of a remote-controlled flying object system 500 with a motion sensor module 540 that includes a gyro-sensor 600, a g-sensor 605 and a magnetic sensor 720. The gyro-sensor 600 of the motion sensor module 540 comprises at least one axis (shown in FIG. 4), the g-sensor 605 of the motion sensor module 540 comprises at least two axes, and the magnetic sensor 720 comprises three axes. The motion sensor module 540 is provided to measure motion signals when the handheld device in the form of a smartphone 530 is operated at three-dimensional movements. The motion signals can be output parameters representative of one or more motion data in acceleration, angular speed and magnetic flux, so as to calculate orientation values, gravity changes and linear accelerations of the flying object.

In the second and third embodiments, the flying object 510 is a remote control helicopter aircraft or jet aircraft. The flying object 510 is flown to a designated elevation and maintains to hovering in place at a height of between 1.0 to 2.5 meters from the ground while maintaining substantial positional and rotational stability. FIG. 4 shows an orientation of the handheld device 530 round its three pitch, yaw, and roll axes with respect to the corresponding orientations of the flying object 510, which includes rotations around three pitch, yaw, and roll axes.

In the second and third embodiments, the flying object 510 further comprises a g-sensor 605, and one or more motors or engines for driving one or more propellers or jets, respectively.

In the second and third embodiments, the flying object 510 has a plurality of motors for driving a plurality of propellers, and continuously calculating a measured value of Gsum, where Gsum=sqrt(Gx̂2+Gŷ2+Gẑ2), where Gx, Gy and Gz are measured values respectively from each of three gravity-acceleration along x-axis, y-axis and z-axis (shown in FIG. 4) of the g-sensor 605 of the flying object 510; in which immediately upon detecting that Gsum is equal to zero as measured by the g-sensor measurements (Gsum=sqrt(Gx̂2+Gŷ2+Gẑ2)=0), such as, for example, when the helicopter aircraft is free falling from the air into the ground or when the helicopter aircraft loses the wireless communication link with the handheld device (the smarthphone 530) due to interference or excessive distance therebetween, the throttle of the motors is immediately thereby increased at a specified rate to rotate the propellers in an incremental manner so as to refrain the helicopter aircraft from crashing into the ground. The helicopter aircraft includes a pressure sensor, and upon detecting at least a preset rate of pressure change using the pressure sensor in the case when the helicopter aircraft is free falling from the air, the throttle and the motor speed are thereby increased accordingly at an incremental rate to rotate the propellers faster and prevent the helicopter drone from unintentional crash.

In the second and third embodiments, information about the flying object 510 (such as its status, its position, speed, motor rotation speed, etc.) can be used as flight data which are sent by the flying object 510 to the handheld device/smartphone device 530 through the wireless communication unit on a UDP port on the handheld device. They are sent approximately at 30 times per second. Besides, the flying object 510 is provided with a gyro-sensor 600 and a g-sensor 605, and the flying object 510 further performs one or more flight corrections due to any abrupt changes in pitch and roll based upon data collected from continuous measurements by the g-sensor 605 in the flying object 510 so as to calibrate the flight corrections of the flying object 510 determined upon offset data of the gyro-sensor 600 inputted from the continuous measurements of the g-sensor 605 at the flying object 510.

In the second and third embodiments, the helicopter aircraft is configured with a camera on-board. A plurality of video images can be captured by the camera, and wirelessly transferred through the wireless communication link to the handheld device (the smartphone device 530), and displayed on the touch screen 535. The user can perform image zoom-in and zoom-out of the captured video displayed on the touch screen 535 (based on the camera zoom-focus) via the multi-touch functionality of the touch screen 535 via one or more multi-touch de-pinch gestures, or through a slide bar operated by one finger.

In the second and third embodiments, the warning messages can be displayed on the touch screen 535 of the smartphone device 530 (handheld device) for including at least the following events:
a) detecting if the battery power on the helicopter drone is too low;
b) detecting if the wireless signal connection loss;
c) detecting if the video connection loss;
d) detecting any engine/motor problems;
e) detecting if the sudden stopping of the helicopter drone. In the event that flight correction of the helicopter drone is needed as when experienced during some of the above events, the helicopter drone includes a gyro-sensor 600 inside thereof, and would then perform one or more flight corrections due to any abrupt changes in pitch and yaw based upon data collected from continuous measurements by the gyro-sensor 600 in the helicopter.

Referring to FIG. 3B again, the remote-controlled flying object system 500 according to the third embodiment of instant disclosure is shown. The remote-controlled flying object system 500 includes a flying object 510, a wireless communication unit 520, and a handheld device 530. The flying object 510 has a g-sensor 605 which is provided to detect an acceleration of gravity direction of the flying object 510, so as to prevent the flying object from crash because the g-sensor 605 of the flying object 510 can measure the acceleration and sent the acceleration measurements to its processor for calculation of such value of Gsum (described in the first embodiment) that the flying crash can be determined and avoided on real time basis; the wireless communication unit 520, respectively provided at the smartphone device (handheld device) 530 and the flying object 510, establishes wireless communication link between the smartphone device 530 and the flying object 510 via a plurality of infrared or radio-frequency signals; the handheld device 530 has a touch screen 535, a motion sensor module 540 having a gyro-sensor 600 and a g-sensor 605 for controlling the roll, yaw, and pitch of the flying object 510, a flight control and piloting interface 550 on the touch screen 535 displaying one or more specified icon or one or more piloting symbols, and a flight control software program 560 configured with the flight control and piloting interface 550, the motion sensor module 540, and the wireless communication unit 520; the flight control software program 560 is configured for activating a plurality of piloting commands and performing a plurality of piloting actions including roll, yaw, and pitch on the flying object through the wireless communication link. The motion sensor module 540 in the third embodiment has a gyro-sensor 600 for controlling the heading of the flying object 510 by sensing the rotation of the handheld device 530 around its yaw axis (e.g., a clockwise rotation indicating a negative direction as shown in FIG. 4), and for controlling the rotation in place of the flying object 510 around its yaw axis by sensing the rotation of the handheld device 530 around its yaw axis, and a g-sensor 605 for controlling the pitch and roll of the flying object 510 by sensing the rotation of the smartphone device 530 around its pitch axis (e.g., a clockwise rotation indicating a negative direction as shown in FIG. 4) and roll axes (e.g., a clockwise rotation indicating a negative direction as shown in FIG. 4), respectively. Moreover, the flying object 510 further may have another gyro-sensor (not shown) that controls the speed of each propeller (or jets) for stabilization under all circumstances to avoid malfunction such as flipping over. It is noted that other embodiments in which yaw/roll/pitch rotations in a clockwise direction around three axes may indicate a positive direction in each of three axes should also be covered in the instant disclosure.

In the third embodiment, the wireless communication unit 520 provides continuous wireless communication link via infrared or radio-frequency signals. The handheld device 530 includes the flight control and piloting interface 550 on the touch screen 535 displaying one or more specified icon or one or more piloting symbols. In addition, a flight control software program 560 is found in the handheld device/smartphone device 530, which is configured with the flight control and piloting interface 550 and the motion sensor module 540; the flight control software program 560 is further configured with the wireless communication unit 520 for activating a plurality of piloting commands and performing a plurality of piloting actions such as roll, yaw, and pitch on the flying object 510. The gyro-sensor 600 in the handheld device 530 controls the heading of the flying object 510 by the user rotating the smartphone device (handheld device) 530 around its yaw axis, and controls the rotation in place of the flying object 510 around its yaw axis by the user rotating the handheld device 530 around its yaw axis. The g-sensor 605 in the handheld device 530 controls the pitch and roll of the flying object 510 by the user rotating the handheld device 530 around its pitch axis and roll axes, respectively. In the above embodiments, the motion signals for three-dimensional orientation motions of the smartphone device 530 can be further processed via a sensor fusion technology developed from Cywee Group Ltd.

Referring to FIG. 3C, the handheld device 530 for the remote-controlled flying object system according to the embodiment is shown in a block diagram; the handheld device 530 includes a touch panel 1010, a motion sensor module 1020, a display 1030, a I/O module 1040, a RAM 1060, a ROM 1070, a hard drive 1080, and a CPU 1050. The motion sensor module 1020 can be the same as the motion sensor module 540 of the second and third embodiments.

A remote-controlled flying object system for using a handheld device is disclosed herein (not shown) according to a fourth embodiment of the present invention. The remote-controlled flying object system comprises a flying object, and a wireless communication unit. The flying object is attached with a g-sensor for detecting an acceleration of a gravity direction of the flying object based on one or more measurements of the acceleration so as to prevent flying crash. The wireless communication unit establishes a wireless communication link between the handheld device and the flying object via a plurality of infrared or radio-frequency signals. The handheld device further comprises a touch screen, a motion sensor module, a flight control and piloting interface and a flight control software program. The motion sensor module has a gyro-sensor and a g-sensor for measuring roll, yaw and pitch angles, and translation of the handheld device. The flight control and piloting interface is provided to display one or more specified icons or piloting symbols to allow the operator's touch gestures to interact with the touch screen. the gyro-sensor of the handheld device is provided to control a heading of the flying object by rotating the handheld around its yaw axis, the g-sensor of the handheld device is provided to control the pitch and roll of the flying object by rotating the handheld device around its pitch axis and roll axes, and the flying object is a remote control helicopter aircraft or remote control jet aircraft.

In the fourth embodiment, the flight control software program is provided to receive a plurality of piloting commands respectively from the flight control and piloting interface and the motion sensor module, so as to maintain an orientation of the flying object. The g-sensor of the motion sensor module is activated in response to an operator input to the g-sensor thereof. The plurality of piloting commands are interpreted by the flight control software program to generate a plurality of corresponding piloting actions so as to control roll, yaw and pitch angles and translation of the flying object through the wireless communication link between the handheld device and the flying object. The gyro-sensor of the handheld device is provided to control a heading of the flying object by rotating the handheld device around its yaw axis, the g-sensor of the handheld device is provided to control the pitch and roll of the flying object by rotating the handheld device around its pitch axis and roll axes, and the flying object is a remote control helicopter aircraft or remote control jet aircraft.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A method of implementing remote-control of a flying object using a handheld device, the method comprising:
activating the flying object to inspect status of the flying object when an operator uses one or two hands to hold the handheld device;
establishing a wireless communication link between the flying object and the handheld device in response to the activating;
detecting an operator input to a motion sensor module of the handheld device wherein the motion sensor module comprises a gyro-sensor and a g-sensor;
generating one or more piloting commands from the operator through moving and/or touching gestures for the handheld device in response to the detecting; and
executing one or more piloting actions based on the piloting commands for controlling the flying object from the handheld device;
wherein the one or more piloting actions are processed to maintain an orientation of the flying object, and the orientation is indicative of at least one of a roll, yaw and pitch angles, and translation thereof during flight;
wherein the gyro-sensor of the handheld device is provided to transmit its one or more motion signals in response to the operator input to the gyro-sensor of the motion sensor module so as to control a flight heading of the flying object around its yaw axis while the handheld device is rotated by the operator around its yaw axis; and
wherein the g-sensor of the handheld device is provided to transmit its one or more motion signals so as to control a flight translation of the flying object or the pitch and roll angles thereof, by tilting the handheld device around at least one of its pitch and roll axes.

2. The method of implementing remote-control of the flying object as claimed in claim 1, wherein the flying object is a remote-control helicopter aircraft or jet aircraft flying to a designated elevation and hovering in place while maintaining substantial positional and rotational stability.

3. The method of implementing remote-control of the flying object as claimed in claim 1, wherein the gyro-sensor of the motion sensor module comprises at least one axis, and the g-sensor of the motion sensor module comprises at least two axes.

4. The method of implementing remote-control of the flying object as claimed in claim 3, wherein the motion sensor module further comprises a three-axis magnetic-sensor to measure one or more motion data in acceleration, angular speed and magnetic flux.

5. The method of implementing remote-control of the flying object as claimed in claim 2, wherein the flying object comprises an g-sensor and one or more motors or engines for driving one or more propellers or jets, respectively, and upon determining that the flying object is free falling from the air when a zero value of Gsum is obtained by performing a square root operation on the following expression:
(Gx̂2+Gŷ2+Gẑ2), where Gx, Gy and Gz are measured values respectively from each of three gravity-acceleration along x-axis, y-axis and z-axis of the g-sensor of the flying object; and
the throttle of the one or more motors or engines is thereby increasingly driven to rotate the corresponding one or more propellers or jets based on the zero value of Gsum.

6. The method of implementing remote-control of the flying object as claimed in claim 2, wherein the flying object comprises one or more motors for driving one or more propellers, and upon determining that the flying object is free falling from air by detecting at least a preset rate of pressure change using a pressure sensor disposed on the flying object, the throttle of the one or more motors is thereby increasingly driven to rotate the one or more propellers.

7. The method of implementing remote-control of the flying object as claimed in claim 3, wherein the motion signal indicates three-dimensional movements of the handheld device detected by the motion sensor module for each of a plurality of corresponding output parameters from the motion sensor module representing acceleration, angular speed, so as to calculate an orientation value, gravity changes and linear accelerations of the flying object.

8. The method of implementing remote-control of the flying object as claimed in claim 4, wherein the motion signal indicates three-dimensional movements of the handheld device detected by the motion sensor module for each of a plurality of corresponding output parameters from the motion sensor module representing acceleration, angular speed, magnetic flux, so as to calculate orientation values, gravity changes and linear accelerations of the flying object.

9. The method of implementing remote-control of the flying object as claimed in claim 8, wherein the motion signal is further processed via sensor fusion technology.

10. The method of implementing remote-control of the flying object as claimed in claim 1, further comprising executing a power saving action by detecting a value of the flying object's height measured from the ground via one or more readings obtained from an altimeter or a pressure sensor disposed on the flying object to automatically adjust the rotating speed of the one or more propellers or jets, so as to prevent the flying object from crash.

11. The method of implementing remote-control of the flying object as claimed in claim 1, wherein the wireless communication link between the flying object and the handheld device is implemented via radio frequency (RF) or infrared (IR) or wireless local area network (WLAN).

12. The method of implementing remote-control of the flying object as claimed in claim 1, wherein the flying object is provided with a gyro-sensor and a g-sensor, the flying object further performing one or more flight corrections due to any abrupt changes in pitch and roll based upon data collected from continuous measurements by the g-sensor in the flying object; and calibrating the flight corrections of the flying object determined upon offset data of the gyro-sensor inputted from the continuous measurements of the g-sensor at the flying object.

13. The method of implementing remote-control of the flying object as claimed in claim 1, wherein each of the piloting commands is activated by the operator's one or more finger gestures on a touch screen of the handheld device at a specified icon or moving over the touch screen at one or more locations of a plurality of piloting symbols displayed on the touch screen.

14. The method of implementing remote-control of the flying object as claimed in claim 13, wherein the flying object further comprises a camera that captures a plurality of still images, and the still images are transferred to the handheld device and displayed on the touch screen; and
wherein the camera captures one or more moving images, and the moving images are transferred to the handheld device for zoom-in/zoom-out operations of the displayed moving images, based on the camera's zoom-focus via multi-touch de-pinch/pinch finger gestures on a particular portion of the touch screen.

15. The method of implementing remote-control of the flying object as claimed in claim 1, wherein the flight translation is indicative of forward, backward, leftward or rightward movement of the flying object.

16. A system for remote control of a flying object using a handheld device, comprising:
a flying object attached with a g-sensor for detecting an acceleration of a gravity direction of the flying object based on one or more measurements of the acceleration so as to prevent flying crash; and
a wireless communication unit for establishing a wireless communication link between the handheld device and the flying object via a plurality of infrared or radio-frequency signals, wherein the handheld device comprises:
a touch screen;
a motion sensor module having a gyro-sensor and a g-sensor for measuring roll, yaw and pitch angles, and translation of the handheld device;
a flight control and piloting interface for displaying one or more specified icons or piloting symbols to allow an operator's touch gestures to interact with the touch screen; and
a flight control software program for receiving a plurality of piloting commands respectively from the flight control and piloting interface and the motion sensor module, so as to maintain an orientation of the flying object;
wherein the g-sensor of the motion sensor module is activated in response to an operator input to the g-sensor thereof;
wherein the plurality of piloting commands are interpreted by the flight control software program to generate a plurality of corresponding piloting actions so as to control roll, yaw and pitch angles and translation of the flying object through the wireless communication link between the handheld device and the flying object.

17. The system as claimed in claim 16, wherein the gyro-sensor of the handheld device is provided to control a heading of the flying object by rotating the handheld around its yaw axis, the g-sensor of the handheld device is provided to control the pitch and roll of the flying object by rotating the handheld device around its pitch axis and roll axes, and the flying object is a remote control helicopter aircraft or remote control jet aircraft.

18. A system for remote control of a flying object using a handheld device, comprising:
a flying object;
a wireless communication unit for establishing a wireless communication link between the handheld device and the flying object via a plurality of infrared or radio-frequency signals, wherein the handheld device comprises:
a touch screen;
a motion sensor module having a gyro-sensor and a g-sensor for measuring roll, yaw and pitch angles, and translation of the handheld device;
a flight control and piloting interface for displaying one or more specified icon or one or more piloting symbols to allow an operator's touch gestures to interact with the touch screen; and
a flight control software program for residing in the handheld device and for receiving a plurality of piloting commands respectively from the flight control and piloting interface and the motion sensor module, so as to maintain an orientation of the flying object;
wherein the g-sensor of the motion sensor module is activated in response to an operator input to the g-sensor thereof;
wherein the plurality of piloting commands are interpreted by the flight control software program to generate a plurality of corresponding piloting actions so as to control roll, yaw and pitch angles and translation of the flying object through the wireless communication link between the handheld device and the flying object.

19. The system as claimed in claim 18, wherein the gyro-sensor of the handheld device is provided to control a heading of the flying object by rotating the handheld around its yaw axis, the g-sensor of the handheld device is provided to control the pitch and roll of the flying object by rotating the handheld device around its pitch axis and roll axes, and the flying object is a remote control helicopter aircraft or remote control jet aircraft.

20. The system as claimed in claim 19, wherein the flying object is attached with a g-sensor for detecting an acceleration of a gravity direction of the flying object based on one or more measurements of the acceleration so as to prevent flying crash.
